(19) United States
(12) Patent Application Publication
(10) Pub. No.: US 2024/0054175 A1
(43) Pub. Date: Feb. 15, 2024

(54) AI-ASSISTED LINEAR PROGRAMMING SOLVER METHODS, SYSTEMS, AND MEDIA

(71) Applicants: Laurent CHARETTE, Vancouver (CA); Zirui ZHOU, Surrey (CA); Yong ZHANG, Richmond (CA)

(72) Inventors: Laurent CHARETTE, Vancouver (CA); Zirui ZHOU, Surrey (CA); Yong ZHANG, Richmond (CA)

(21) Appl. No.: 17/886,339

(22) Filed: Aug. 11, 2022

(51) Int. Cl. G06F 17/11; G06F 17/16; G06N 5/02

(52) U.S. Cl. CPC G06F 17/11; G06F 17/16; G06N 5/02

(57) ABSTRACT

Methods, systems, and computer-readable media for using artificial intelligence to assist a linear programming (LP) solver are disclosed. A LP assistance software system leverages the categorization of variables to improve LP solver efficiency at the pricing step and/or to generate a custom initial basis for the first iteration of the simplex method. The LP assistance software system may thereby improve the standard simplex algorithm, which involves selecting individual variables in its pricing step.

### RELATED APPLICATION DATA

This is the first patent application related to this matter.

### FIELD

The present disclosure relates to linear programming, including linear programming solvers assisted by artificial intelligence.

### BACKGROUND

Many companies, organizations, and government agencies need to optimize their operations for a multitude of reasons, such as maximizing profits, making operations more efficient, or providing better products or services. To achieve this task, they must often solve linear programming (LP) problems which consist of an objective function to optimize (i.e. maximize or minimize) for a set of variables under several constraints these variables must satisfy.

The nature of these optimization tasks is often recurrent in time, such that a new problem of the same type needs to be solved periodically. Moreover, these optimization problems often consist of an immense number of variables and constraints and can take a considerable amount of computing time and resources to solve. Thus, any improvement in the efficiency of LP solver software is important to end users.

A linear programming problem consists of minimizing or maximizing an objective function over a set of n variables x=(x₁, x₂, . . . , xₙ)^{T}:

min g(x)=c^{T}x. (1)

The objective function is linear with respect to x with coefficients given by a vector c=(c₁, c₂, . . . , cₙ)^{T}. Moreover, the variables must satisfy a set of m linear constraints:

αᵢ^{T}x≤bᵢ, (2)

And each variable is subject to its individual fixed bound (simplified by using zero here):

x≥0. (3)

The constraint coefficient vectors αᵢ^{T} may be stacked into a m×n matrix, and the constraints may be expressed as a vector inequality using a matrix product:

Ax≤b. (4)

The constraints inequalities can be changed into an equality by introducing a logical variable (also called a slack or row variable) indicating the gap between the constraint and its boundary value:

Ax+v=b,v≥0. (5)

The LP problem can thus be considered as optimizing the objective function (1) over m+n variables subject to the constraint equalities (5).

Simplex methods are a type of LP problem optimization algorithms that are commonly used to solve LP problems. The constraints in the LP problem definition (4) create a zone in x-space where a solution is feasible. The bounds of this zone create a convex polyhedron shape. Due to the linearity of the objective function, the optimal solution must include a vertex of the bounding polyhedron, unless the problem is unbounded.

Each vertex of the bounding polyhedron corresponds to a basic solution, where n variables (considering x and v) are at their bounds (0 in the simplified definition above) and m variables set to solve the constraints. The latter m variables are called basic variables, while the other n are called non-basic variables.

The simplex method starts at one feasible basic solution, then swaps one basic and one non-basic variable in and out of the basis in a way that improves the objective value, and continues until no such improvements can be made and we obtain the solution.

FIG. 2B (prior art) shows a simplified diagram illustrating a simplex method. The feasible region 250 in variable space is bound by the zero bounds of both x variables x₁ 252 and x₂ 254 and the equality equations of each constraint 256. In that example both variables x₁,x₂ are non-basic, and fixed to their zero fixed bound. The first iteration 260 chooses x₁ to enter the basis in exchange to one of the logical variables and the solution moves to the next vertex 262, at the intersection of the two non-basic variable bounds (x₂=0 and the now non-basic constraint being at equality). The second iteration 264 and third iteration 266 similarly move the solution to new vertices of the polyhedron shape of the feasible region 250.

The simplex method comes in two varieties. The primal simplex method works exactly as previously described, whereas the dual simplex method works on a connected problem, called the dual problem. The optimization process of the dual problem is slightly different from that of the primal method, but relies on the same fundamental ideas of exchanging variables in and out of a basic solution until a solution is reached.

For both simplex methods there is a pricing step of the algorithm, wherein a pivot variable is chosen. The pivot variable is an incoming variable for primal simplex, meaning a variable that is added to the basis (i.e., the variable changes from a non-basic variable to a basic variable)—it may be said that the variable is pivoted in to the basis. The pivot variable is a leaving variable for dual simplex, meaning a variable that is removed from the basis (i.e., the variable changes from a basic variable to a non-basic variable)—it may be said that the variable is pivoted out of the basis. In both methods, the pivot variable is chosen according to a heuristic method weighing different features of each variable and selecting the most desirable. Many different fast heuristics exist, but it is shown that none can be the most efficient in all situations.

Some existing techniques have been developed for improving the efficiency of algorithms relating to solving LP problems, including at least one approach leveraging artificial intelligence to improve pricing heuristics used by simplex methods.

One existing approach is called DeepSimplex. DeepSimplex incorporates machine learning in the pricing step of the simplex method. In DeepSimplex, a decision model is trained such that, at every simplex iteration, the model decides between two pricing heuristics (the pricing heuristics are called “pivot rules” in the published work on DeepSimplex). One such heuristic (called “Dantzig”) is less powerful but faster to compute, and the other heuristic (called “steepest-edge”) will likely produce better pivots, but take longer to compute. By selecting the steepest-edge heuristic only if needed, DeepSimplex may potentially save computing time when solving some LP problems.

In DeepSimplex, a series of 5-node travelling salesman problems are generated and then converted into LP problems. The problems are then used to train the pivot heuristic decision model. Reinforcement learning is used to train the model, where the reduced costs are fed to the model, which makes a decision, and the resulting basic state is given a reward score that penalizes each step before reaching the optimal solution. The training rewards the finding of the optimal solution. The penalties are weighted by the computational cost of each heuristic.

However, DeepSimplex exhibits certain limitations. First, DeepSimplex's model is fixed to the shape of the LP problem it is trained to solve, because the input shape must have a fixed number of variables. Thus, for example, a DeepSimplex model trained on 5-node traveling salesman problem will not be usable to solve a 6-node problem. Second, it is unclear from the published results of the DeepSimplex researchers if DeepSimplex exhibits any improvement in efficiency: the efficiency of the technique appears to be roughly equal to that of the steepest-edge heuristic in the best case.

A second class of existing approaches is a set of techniques for solving mixed integer problems (MIP). MIPs are the same as LP problems, except that there is an extra constraint that some of the variables must be integers. Common MIP solving algorithms consist of solving the MIP as a LP problem first, without the integrality constraints. Then a tree search on the integral variables is performed to find which of their two nearest values (one below, one above) returns a better objective value while remaining feasible.

Choosing which variables to branch at next relies on a series of different heuristics that can be computationally intensive, so some existing approaches use a machine learning model to make that decision more efficiently. One example, MIP-GNN, uses a set of near optimal solutions on training problems as its training data. The input feature of data instances are the adjacency graphs of constraints and variables, and the labels are the biases of each variables (upper value or lower value).

However, these machine learning approaches to improving MIP solvers are limited in their applicability to LP solvers. MIP branching models like MIP-GNN work well in the case of MIP problems, but are not useful for solving LP problems. The simplex methods used in LP problem solving have no such tree search component to them.

Thus, there exists a need for techniques for improving the efficiency and/or effectiveness of LP solvers that overcome one or more of the limitations of the existing approaches described above.

### SUMMARY

In various examples, the present disclosure describes methods, systems, and computer-readable media for using artificial intelligence to assist a linear programming solver.

In practical applications, LP problems in a recurrent series will be of the same type, such that they will likely share different types of variables that have a similar role in the problem's objective function and its constraints. These shared categories of variables suggest similarities in structure between problems in the same series, or otherwise of the same type, that could possibly be exploited by LP solver software. Existing approaches to improving LP solver efficiency do not consider any explicit categorization of variables in their optimization algorithms.

Examples described herein may leverage the categorization of variables to improve LP solver efficiency at the pricing step and/or to generate a custom initial basis for the first iteration of the simplex method. In some examples, implicit categorization of the variables may be derived from common prefixes in the variables' labels in LP problem files to improve the efficiency of the optimization algorithms in a LP solver. Some examples may thereby improve the standard simplex algorithm, which involves selecting individual variables in its pricing step.

An example of variable categorization reflected in the category data for a LP problem definition will now be described. A power utility company has been solving periodic, recurrent LP problems of the same type to optimize the benefits of its energy transactions with other energy utilities. After providing for domestic demands, the power utility company may output more electricity and sell it to other energy utilities. The amount of extra power to generate is decided by optimizing a benefit function and constraints depending on many equipment, plant, and market variables. These variables may be categorized by based on their data source: for example, variables relating to hydroelectric data may include reservoir data, turbine data, and regulation data; other variables may relate to thermal data; and still other variables may relate to market data. Thus, the LP problem may include variables originating from or relating to three sources, with one source having three sub-sources, thereby potentially resulting in category data grouping the variables into three categories (hydroelectric, thermal, market), five categories (reservoir, turbine, regulation, thermal, market), or some other configuration of categories. To keep on top of the market fluctuations and capacity of their production, the power utility company must solve one LP problem hourly, wherein the type of LP problem to be solved each hour requires finding a solution that defines a trade balance and a thermal ratio that optimizes an objective function.

Some embodiments described herein may provide a LP assistance software system with various modules that are used to improve the efficiency and/or effectiveness of a LP solver by making use of category data relating to the variables of a predetermined type of LP problem, such as a recurrent LP problem. A custom basis module of the LP assistance software system may be used to generate a custom basis for the first iteration of a simplex method used by the LP solver, thereby providing an improved starting point for the simplex method that is likely to be close to the optimal basis, based on the category data of the problem. A training module is used to train a machine learning model to perform the pricing step of a simplex method on the predetermined type of LP problem, by leveraging the category data. Once the model is trained, an augmented solver performs a simplex method, augmented by the trained model performing the pricing step, to solve new LP problems of the predetermined type, by leveraging the category data.

Embodiments described herein may thereby solve the technical problem of providing a method that can improve the efficiency of LP solvers by leveraging the categorization of LP problem variables. Specifically, examples described herein may improve the functioning of a computer in solving LP problems through increased efficiency, adaptability, and/or generality. Increased efficiency means that, given a series of recurrent LP problems, examples described herein may solve each problem in less time on average compared to the same solver not using the features described herein. Examples described herein may reduce the number of iterations of the simplex algorithm needed to solve a LP problem, thereby reducing the problem's solving time. Adaptability means that the examples described herein should be compatible with different LP problems of a predetermined type, e.g., LP problems within the same recurrent series, even if each problem has a different number of variables and category composition. Because examples described herein may depend on a fixed list of all possible categories, they may be used to solve LP problems of different sizes and LP problems with missing categories in their composition. Generality means that examples described herein are not limited to a single application of LP problems. Examples described herein may be compatible with recurrent LP problems, or other LP problems of a common predetermined type, no matter their application by using features common to all LP problems and the category features of the LP problem being solved. In some examples, the techniques described herein may be used to improve the efficiency of LP solvers for any problem of a predetermined type (e.g., in a recurrent series of problems) with a similar structure, but whose variable and category composition may differ.

As used herein, the terms “linear programming” or “LP” refer to a discipline or set of techniques for maximizing or minimizing a linear objective function subject to constraints on its variables. A “linear programming problem” refers to a given set of variables and constraints, and an objective function of the variables, defining a specific problem to be solved using linear programming. A “linear programming problem type” refers to a type of linear programming problem, such as a set of all linear programming problems sharing a common set of variables and an objective function, but having different constraints. A “recurrent” linear programming problem type refers to a sequence of linear programming problems defined over time with respect to a given system, such that the variables and objective function remain constant but the constraints change each time the problem recurs. An example of a recurrent linear programming problem type is a problem wherein the power output of a power plant must be maximized each hour, based on a set of constraints defined by the current conditions present at that hour.

As used herein, the terms “mixed integer programming problem” or “MIP problem” refer to a problem requiring an objective function to be optimized, as in a LP problem, with the added constraints that a subset of the variables must be integers.

As used herein, the term “solution” refers to a set of variable values for a LP problem. A “feasible solution” refers to a solution that also satisfies the constraints of the LP problem. An “optimal solution” refers to a feasible solution that generates the optimal (i.e., maximum or minimum) objective function value.

As used herein, the term “basis” refers to a set of variables of a LP problem fully solving the constraint equations. Any variable not in the basis is set at a fixed individual bound. Variables in the basis are referred to as “basic” variables; those not in the basis are “non-basic” variables.

As used herein, the terms “simplex”, “simplex method”, or “simplex algorithm” refer to a commonly-used type of iterative algorithm for solving LP problems by improving the objective function by replacing variables one-by-one from a valid basis. Simplex algorithms include primal simplex and dual simplex. The dual simplex algorithm is a variant of the primal simplex method optimizing an analogous dual problem to find the same optimal value.

As used herein, the terms “pricing” or “pricing step” refer to a step in simplex methods wherein a pivot variable is selected to be swapped in (in primal simplex) or swapped out (in dual simplex) of the basis, typically according to a heuristic used by the simplex algorithm. The heuristic may be referred to as a “simplex heuristic”. Swapping in a variable may be referred to as adding a variable to the basis; swapping out a variable may be referred to as removing a variable from the basis. The term “price” should be understood to refer to any metric of desirability for a given purpose, not simply a monetary or financial price.

As used herein, the term “pivot variable” refers to a variable selected to be swapped in or swapped out by a pricing step.

As used herein, the term “category” refers to any grouping of variables by one or more shared characteristics. In some cases, if some variables are not categorized, they can be regarded as being in the category “uncategorized”.

As used herein, the term “model” may refer to a mathematical or computational model. A model may be said to be implemented, embodied, run, or executed by an algorithm, computer program, or computational structure or device. In the present example embodiments, unless otherwise specified a model refers to a “machine learning model”, i.e., a predictive model implemented by an algorithm trained using deep learning or other machine learning techniques, such as a deep neural network (DNN).

As used herein, the term “machine learning” (ML) may refer to a type of artificial intelligence that makes it possible for software programs to become more accurate at making predictions without explicitly programming them to do so.

As used herein, an “input sample” may refer to any data sample used as an input to a machine learning model, such as image data. It may refer to a training data sample used to train a machine learning model, or to a data sample provided to a trained machine learning model which will infer (i.e. predict) an output based on the data sample for the task for which the machine learning model has been trained. Thus, for a machine learning model that performs a task of image classification, an input sample may be a single digital image.

As used herein, the term “training” may refer to a procedure in which an algorithm uses historical data to extract patterns from them and learn to distinguish those patterns in as yet unseen data. Machine learning uses training to generate a trained model capable of performing a specific inference task.

As used herein, the term “reinforcement learning” refers to a machine learning technique consisting of training a model to select actions within an environment to maximize a cumulative reward per episode.

As used herein, the term “supervised learning” refers to a machine learning technique consisting of training a model to minimize a difference between a set of data outputs based on respective data inputs, and a set of training labels associated with the data inputs. The training labels represent ground truths corresponding to the data inputs.

As used herein, a statement that an element is “for” a particular purpose may mean that the element performs a certain function or is configured to carry out one or more particular steps or operations, as described herein.

As used herein, statements that a second element is “based on” a first element may mean that characteristics of the second element are affected or determined at least in part by characteristics of the first element. The first element may be considered an input to an operation or calculation, or a series of operations or computations, which produces the second element as an output that is not independent from the first element.

In some aspects, the present disclosure describes a method. A linear programming (LP) problem definition defining a LP problem of a predetermined type is obtained. The LP problem definition comprises variable data specifying a plurality of variables, objective function data specifying an objective function of the plurality of variables, constraint data specifying a plurality of constraints, each constraint constraining a value of at least one of the plurality of variables, and category data specifying, for each variable of the plurality of variables, a respective category. A pricing model is obtained which is trained, using machine learning, to perform a pricing step of a simplex algorithm with respect to LP problems of the predetermined type. The LP problem is solved by generating an initial basis comprising a subset of the plurality of variables, the initial basis being designated as a current basis, and performing one or more iterations of the simplex algorithm on the current basis. Each iteration comprises applying the simplex algorithm to the current basis to generate a set of values for the plurality of variables, generating a value of the objective function based on the set of values for the plurality of variables, and performing the pricing step of the simplex algorithm by processing the category data, using the pricing model, to generate an updated basis comprising a subset of the plurality of variables. The updated basis is designated as the current basis.

In some aspects, the present disclosure describes a method. A linear programming (LP) problem definition defining a LP problem of a predetermined type is obtained. The LP problem definition comprises variable data specifying a plurality of variables, objective function data specifying an objective function of the plurality of variables, constraint data specifying a plurality of constraints, each constraint constraining a value of at least one of the plurality of variables, and category data specifying, for each variable of the plurality of variables, a respective category. A pricing model is obtained which is trained, using machine learning, to perform a pricing step of a simplex algorithm with respect to LP problems of the predetermined type. The LP problem is solved by generating an initial basis comprising a subset of the plurality of variables, the initial basis being designated as a current basis, and performing one or more iterations of the simplex algorithm on the current basis. Each iteration comprises applying the simplex algorithm to the current basis to generate a set of values for the plurality of variables, generating a value of the objective function based on the set of values for the plurality of variables, and performing the pricing step of the simplex algorithm by processing the category data, using the pricing model, to generate an updated basis comprising a subset of the plurality of variables. The updated basis is designated as the current basis.

In some aspects, the present disclosure describes a non-transitory computer-readable medium having instructions tangibly stored thereon that, when executed by a processing system of a computing system, cause the computing system to perform a number of operations. A linear programming (LP) problem definition defining a LP problem of a predetermined type is obtained. The LP problem definition comprises variable data specifying a plurality of variables, objective function data specifying an objective function of the plurality of variables, constraint data specifying a plurality of constraints, each constraint constraining a value of at least one of the plurality of variables, and category data specifying, for each variable of the plurality of variables, a respective category. A pricing model is obtained which is trained, using machine learning, to perform a pricing step of a simplex algorithm with respect to LP problems of the predetermined type. The LP problem is solved by generating an initial basis comprising a subset of the plurality of variables, the initial basis being designated as a current basis, and performing one or more iterations of the simplex algorithm on the current basis. Each iteration comprises applying the simplex algorithm to the current basis to generate a set of values for the plurality of variables, generating a value of the objective function based on the set of values for the plurality of variables, and performing the pricing step of the simplex algorithm by processing the category data, using the pricing model, to generate an updated basis comprising a subset of the plurality of variables. The updated basis is designated as the current basis.

In some examples, processing the category data, using the pricing model, to generate the updated basis comprises selecting one or more variables to be removed from the current basis to generate the updated basis.

In some examples, selecting the one or more variables to be removed from the current basis comprises using the pricing model to identify a category to pivot out, and selecting the one or more variables from the identified category.

In some examples, selecting the one or more variables to be removed from the current basis comprises using the pricing model to generate, for each variable of the current basis, a price score based at least in part on the category of the variable, and processing the price scores to select the one or more variables.

In some examples, processing the category data, using the pricing model, to generate the updated basis comprises processing the category data, using the pricing model, to select one or more variables of the plurality of variables for removal from the current basis, and select one or more variables of the plurality of variables for addition to the current basis.

In some examples, selecting the one or more variables for removal from the current basis and selecting the one or more variables for addition to the current basis comprises using the pricing model to generate, for each variable of the current basis, a price score based at least in part on the category of the variable, and processing the price scores to select the one or more variables for removal from the current basis and select the one or more variables for addition to the current basis.

In some examples, generating the initial basis comprises generating the initial basis as a custom basis based on a plurality of known optimal bases of LP problems of the predetermined type.

In some examples, generating the custom basis comprises selecting the variables of the subset based on a statistical distribution among the plurality of categories of variables of the plurality of known optimal bases.

In some examples, generating the initial basis comprises generating the initial basis as a custom basis by obtaining a custom basis generation model, trained using machine learning to generate a custom basis for a LP problem of the predetermined type, and processing the LP problem definition, using the custom basis generation model, to generate the initial basis.

In some examples, the custom basis generation model is trained by obtaining custom basis training data comprising a plurality of data samples, each data sample comprising constraint data for a respective LP problem of the predetermined type, and an optimal basis for the respective LP problem. The custom basis generation model is trained using supervised learning by, for each data sample, using the LP problem definition as an input to the custom basis generation model, and using the optimal basis as a training label.

In some examples, the pricing model is trained using reinforcement learning by using the pricing model to perform the pricing step of the simplex algorithm in solving a plurality of LP problems of the predetermined type, and using a reward function based at least in part on a number of iterations of the simplex algorithm required to solve a given LP problem.

In some examples, the reward function is also based at least in part on the objective function.

In some examples, the pricing model is trained by obtaining pricing training data comprising a plurality of data samples, each data sample comprising a LP problem definition for a respective LP problem of the predetermined type and a current basis of the respective LP problem, and training the pricing model using supervised learning by, for each data sample, using the LP problem definition and current basis as inputs to the pricing model, and using a training label comprising an estimated optimal updated basis.

In some examples, the estimated optimal updated basis is based on an expert opinion.

In some examples, the estimated optimal updated basis is generated using a simplex pricing heuristic constrained by a known optimal basis for the respective LP problem.

In some examples, the category of a given variable is based on a respective source of the variable.

In some examples, the category of a given variable is based on one or more constraints of the constraint data pertaining to the variable.

In some examples, the method further comprises determining that an optimization condition has been satisfied, and outputting an optimal solution to the LP problem, comprising an optimal set of values for the plurality of variables corresponding to an optimal value of the objective function.

In some examples, generating the initial basis comprises generating the initial basis as a custom basis based on a plurality of known optimal bases of LP problems of the predetermined type. The method further comprises determining that an optimization condition has been satisfied, and outputting an optimal solution to the LP problem, comprising an optimal set of values for the plurality of variables corresponding to an optimal value of the objective function.

In some aspects, the present disclosure describes a non-transitory computer-readable medium having instructions tangibly stored thereon, wherein the instructions, when executed by a processing system of a computing system, cause the computing system to perform one or more of the methods described above.

### BRIEF DESCRIPTION OF THE DRAWINGS

Reference will now be made, by way of example, to the accompanying drawings which show example embodiments of the present application, and in which:

FIG. 1 is a block diagram of an example computing system that may be used to implement examples described herein.

FIG. 2A (prior art) is a schematic diagram of a conventional LP problem solver using a simplex method.

FIG. 2B (prior art) is a graph showing the movement of a solution between vertices of a feasible region of a LP problem during repeated iterations of a simplex method.

FIG. 3 is a schematic diagram of the operation of an example custom basis module of a LP assistance software system, in accordance with the present disclosure.

FIG. 4 is a schematic diagram of the operation of an example training module of a LP assistance software system, in accordance with the present disclosure.

FIG. 5 is a schematic diagram of the operation of an example augmented solver of a LP assistance software system, in accordance with the present disclosure.

FIG. 6 is a flowchart showing operations of a method for using artificial intelligence to assist a LP solver, in accordance with the present disclosure.

FIG. 7A is a schematic diagram of the operation of an example pricing supervised learning module of a LP assistance software system in an alternative embodiment, in accordance with the present disclosure.

FIG. 7B is a schematic diagram of the operation of an example pricing supervised learning module of a LP assistance software system in an alternative embodiment using two sub-models for the pricing model, in accordance with the present disclosure.

FIG. 8 is a schematic diagram of the operation of an example custom basis supervised learning module of a LP assistance software system in a further alternative embodiment, in accordance with the present disclosure.

Similar reference numerals may have been used in different figures to denote similar components.

### DESCRIPTION OF EXAMPLE EMBODIMENTS

Methods, systems, and computer-readable media for using artificial intelligence to assist a linear programming solver will now be described with reference to example embodiments.

Example Computing System

A system or device, such as a computing system, that may be used in examples disclosed herein is first described.

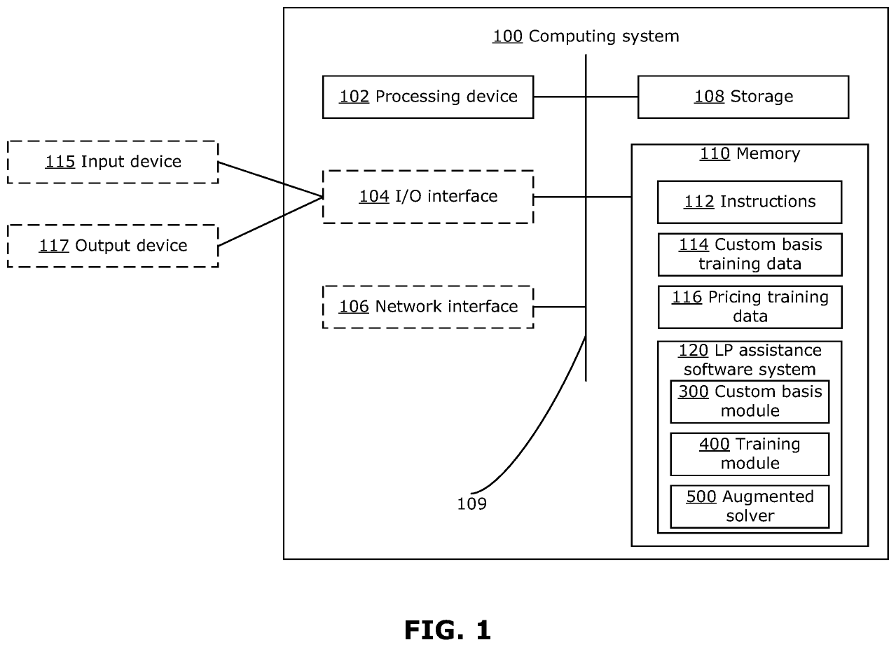

FIG. 1 is a block diagram of an example simplified computing system 100, which may be a device that is used to execute instructions 112 in accordance with examples disclosed herein, including the instructions of a LP assistance software system 120. Other computing systems suitable for implementing embodiments described in the present disclosure may be used, which may include components different from those discussed below. In some examples, the computing system 100 may be implemented across more than one physical hardware unit, such as in a parallel computing, distributed computing, virtual server, or cloud computing configuration. Although FIG. 1 shows a single instance of each component, there may be multiple instances of each component in the computing system 100.

The computing system 100 may include a processing system having one or more processing devices 102, such as a central processing unit (CPU) with a hardware accelerator, a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The computing system 100 may also include one or more optional input/output (I/O) interfaces 104, which may enable interfacing with one or more optional input devices 115 and/or optional output devices 117. In the example shown, the input device(s) 115 (e.g., a keyboard, a mouse, a microphone, a touchscreen, and/or a keypad) and output device(s) 117 (e.g., a display, a speaker and/or a printer) are shown as optional and external to the computing system 100. In other examples, one or more of the input device(s) 115 and/or the output device(s) 117 may be included as a component of the computing system 100. In other examples, there may not be any input device(s) 115 and output device(s) 117, in which case the I/O interface(s) 104 may not be needed.

The computing system 100 may include one or more optional network interfaces 106 for wired or wireless communication with a network (e.g., an intranet, the Internet, a P2P network, a WAN and/or a LAN) or other node. The network interfaces 106 may include wired links (e.g., Ethernet cable) and/or wireless links (e.g., one or more antennas) for intra-network and/or inter-network communications.

The computing system 100 may also include one or more storage units 108, which may include a mass storage unit such as a solid state drive, a hard disk drive, a magnetic disk drive and/or an optical disk drive. The computing system 100 may include one or more memories (collectively memory 110), which may include a volatile or non-volatile memory (e.g., a flash memory, a random access memory (RAM), and/or a read-only memory (ROM)). The non-transitory memory 110 may store instructions 112 for execution by the processing device(s) 102, such as to carry out examples described in the present disclosure. The memory 110 may include other software instructions 112, such as for implementing an operating system and other applications/functions. In some examples, memory 110 may include software instructions 112 for execution by the processing device 102 to implement a LP assistance software system 120, as disclosed herein. The non-transitory memory 110 may store data, such as custom basis training data 114, pricing training data 116, and/or the various other forms of data described herein (such as a LP definition for the LP problem to be solved).

In some other examples, one or more data sets and/or modules may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 109 providing communication among components of the computing system 100, including the processing device(s) 102, I/O interface(s) 104, network interface(s) 106, storage unit(s) 108 and/or memory 110. The bus 109 may be any suitable bus architecture including, for example, a memory bus, a peripheral bus or a video bus. In some examples, the computing system 100 is a distributed computing system and the functions of the bus 109 may be performed by the network interfaces 106 in communication with communication links.

Example LP Assistance Software System

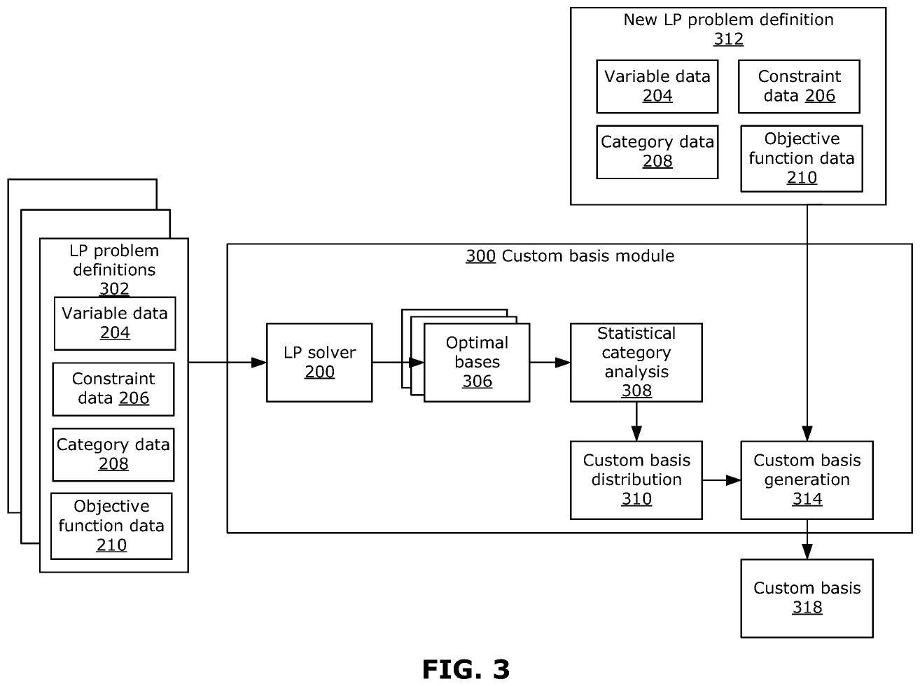

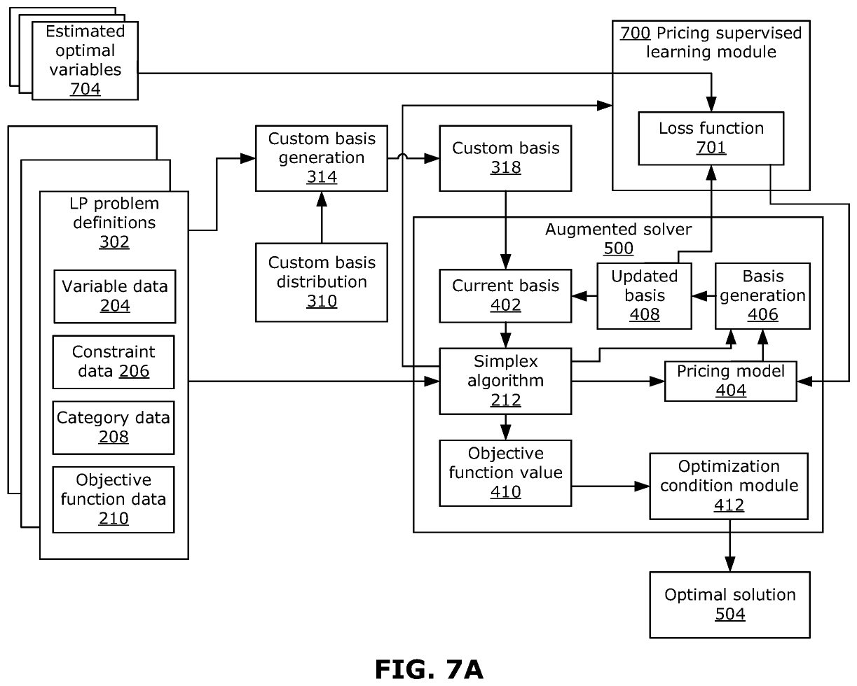

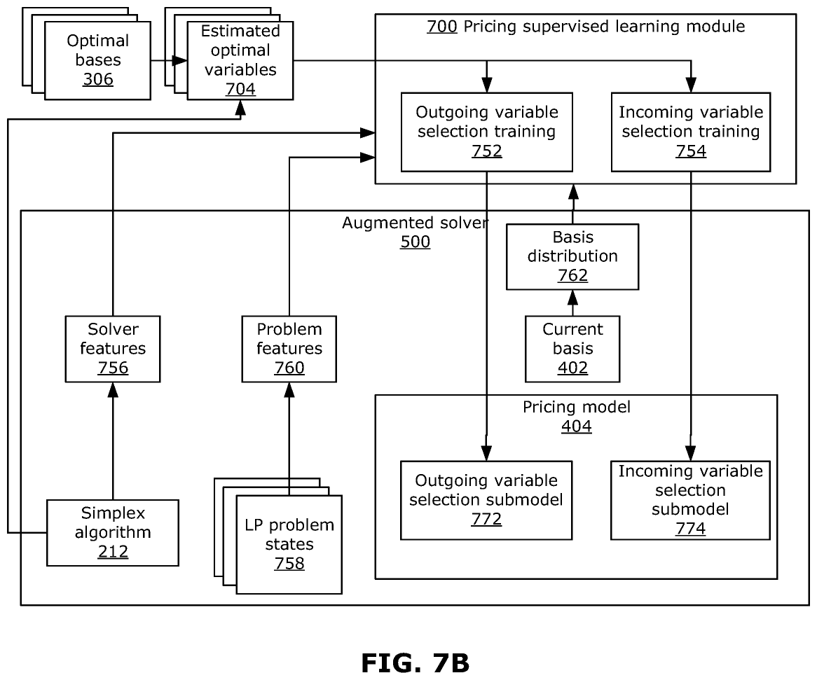

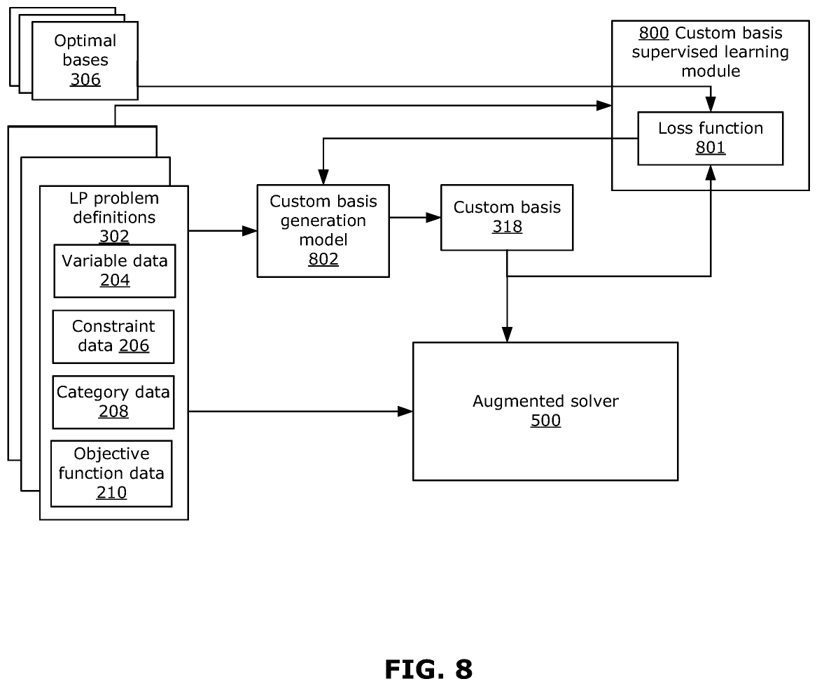

An example LP assistance software system 120 will now be described with reference to FIGS. 3-6. Alternative embodiments of various components of the LP assistance software system 120 will then be described, namely the alternative training modules of FIG. 7A-7B using supervised learning to train a pricing model, and the alternative custom basis module of FIG. 8 comprising a machine learning model trained using supervised learning.

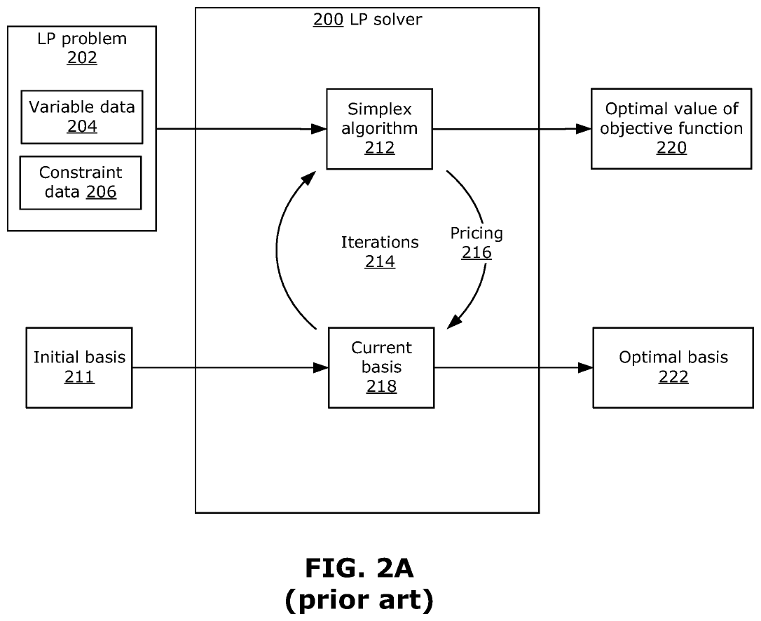

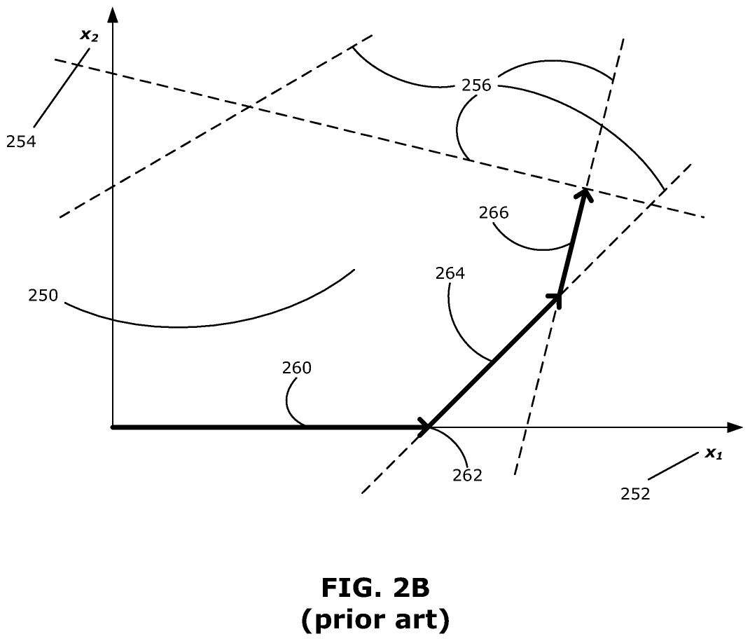

First, however, the operation of a conventional LP solver using a simplex method will be described with reference to FIG. 2A, showing an example of a LP solver solving a LP problem.

FIG. 2A (prior art) is a schematic diagram of a conventional LP solver 200 using a simplex method. The LP solver 200 is provided with a LP problem 202 defined by variable data 204 defining a plurality of variables, and constraint data 206 defining the constraints on the variable values. The LP problem 202 typically also defines an objective function, which may be defined by objective data (not shown) as in the examples of FIGS. 3-8 below.

The LP solver 200 also receives an initial basis 211, indicating a subset of the variables of the variables defined by the variable data 204 that are to be used as the basis in the first iteration of the simplex method. In the first iteration, the simplex algorithm 212 is applied to the LP problem and the initial basis 211 to generate a new current basis 218 using pricing step 216. As shown in FIG. 2B described in the Background section above, this first iteration corresponds to the movement of the current solution to the second vertex 262 of the feasible region 250 of the LP problem as defined by its constraints 256 during first iteration 260. The new current basis 218 is used as the basis for the second iteration, and the simplex algorithm 212 continues to perform iterations 214 to generate new updated bases using pricing step 216, which are used as the current basis 218 for the next iteration until the LP problem 202 is solved. Once the LP problem has been solved by finding the optimal solution, the LP solver 200 may preserve not only the optimal solution (i.e. the optimal values of the variables), but also the optimal basis 222 and optimal value of the objective function 220 corresponding to the optimal solution.

Example LP assistance software systems 120 described herein may be used to assist a LP solver 200 that is used to solve multiple LP problems 202 of a predetermined type, such as LP problems in a recurrent series that have to be solved at a regular interval of time. As described above, recurrent LP problems are very common in the decision making process of many organizations, and these problems can require significant computing resources to be solved.

By the recurrent or other shared nature of the LP problems, the problems of the same type must have some structural similarities shared by the variables in each problem of the series or type. These structural similarities may allow the variables to be grouped in clusters or otherwise categorized. If the variables are labeled according to their data source, or their role in the equations (e.g., the type of constraints they introduce), the category of each variable can be established by extracting this information from each variable's label. It will be appreciated that various techniques may be used to identify structural similarities among groups of variables of LP problems of a predetermined type, such that the variables may be categorized.

In order to solve the LP problems of the predetermined type, LP problem solver software like CPLEX, OptVerse, or COIN-OR may be used. These software packages use a simplex-type optimizer (i.e., primal or dual simplex). The LP assistance software system 120 can be embedded in the simplex solver features of such software products. The LP assistance software system 120 may use information from the variables, including their category data, to guide the simplex algorithm 212 in order to reduce the number of iterations 214 needed to solve a given LP problem of the predetermined type.

Example Custom Basis Module

FIG. 3 is a schematic diagram of the operation of an example custom basis module 300 of a LP assistance software system 120. The purpose of the custom basis module 300 is to start the simplex algorithm at a state closer to the optimal state, hereby reducing the number of solver iterations to reach the optimal solution. The custom basis module 300 does this by first generating a custom basis distribution 310 of basic variables over categories based on past LP problems, and then, when deployed to solve new LP problems, using the custom basis distribution 310 as a reference for generating a custom basis 318 to be used as the initial basis for solving the new LP problem. The custom basis is generated based on the category data 208 of the LP problem being solved, and how this category data 208 relates to the category distributions of the optimal bases of previously solved LP problems of the same predetermined type.

In operation, the custom basis module 300 operates in two modes: an analysis mode performed once to gather and statistically analyse data about the optimal bases of a series of LP problems, and a deployment mode to generate a custom basis for each new LP problem to be solved by a LP solver assisted by the LP assistance software system 120.

In the analysis mode, the custom basis module 300 gathers data about the optimal bases of LP problems of the predetermined type (e.g., other problems in the recurrent series) and analyzes the gathered data to determine a statistical distribution of the variables of the optimal bases among the various categories. The analysis mode may be seen as roughly analogous to a training mode for a machine learning model: in fact, a second example embodiments of the custom basis module 300 is described below with reference to FIG. 8, wherein the custom basis module 300 includes a machine learning model trained during an initial training mode.

In the analysis mode, the custom basis module 300 receives a set or series of LP problems of the predetermined type, such as recurrent LP problems in a recurrent series. Each LP problem is defined by a LP problem definition 302 that includes variable data 204 specifying the variables of the problem, constraint data 206 specifying the constraints of the problem, category data 208 specifying a category for each variable, and objective function data 210 specifying the objective function. In some examples, multiple problems of the same type may share one or more of these data types, which may be stored by the LP assistance software system 120 (e.g. in the memory 110) such that each new LP problem definition 302 received by the LP assistance software system 120 only needs to define the remaining types of data that are idiosyncratic to a new LP problem of the predetermined type.

For each LP problem definition 302 in the series, a conventional LP solver 200 is used to solve the LP problem, for example using a known technique such as a conventional, unassisted simplex method. Once the LP solver 200 identifies the optimal solution to the LP problem, the optimal basis 222 is stored by the custom basis module 300. This process is repeated for each LP problem definition 302. After the LP solver 200 has solved the entire series of LP problems, the stored set of corresponding optimal bases 306 is processed by a statistical category analysis module 308, which computes the category distribution of the variables of each optimal basis 222 in the optimal bases 306 and computes a statistical distribution, aggregated across the entire series of LP problem definitions 302, of the optimal basis variables across all the categories. This statistical distribution is referred to as the custom basis distribution 310. For example, the custom basis distribution may indicate that, based on some statistical aggregation metric, the optimal bases 306 tend to have 20% of their basic variables in category 1, 30% of their basic variables in category 2, and 30% of their basic variables in category 3, then the custom basis distribution 310 could potentially be represented as an array [0.2, 0.3, 0.3].

The generation of the custom basis distribution 310 is the purpose of the analysis mode of the custom basis module 300. In some examples, the custom basis distribution 310 is generated once and stored. In other examples, the custom basis distribution 310 is updated on an ongoing basis based on further LP problem definitions 302 received over time. In this respect as well, the custom basis module 300 in analysis mode resembles a training module for a machine learning model, insofar as it may train the model once and then stop, or it may continued to fine-tune the model over time as new training data is received.

In deployment mode, the custom basis module 300 uses a custom basis generation module 314 to generate a specific custom basis to asset in solving a new LP problem. The new LP problem is received as a new LP problem definition 312. The custom basis generation module 314 applies the custom basis distribution 310 to the new LP problem definition 312 to determine how many variables of each category should be included in a custom basis 318 generated as the initial basis for the new LP problem.

Example Training Module

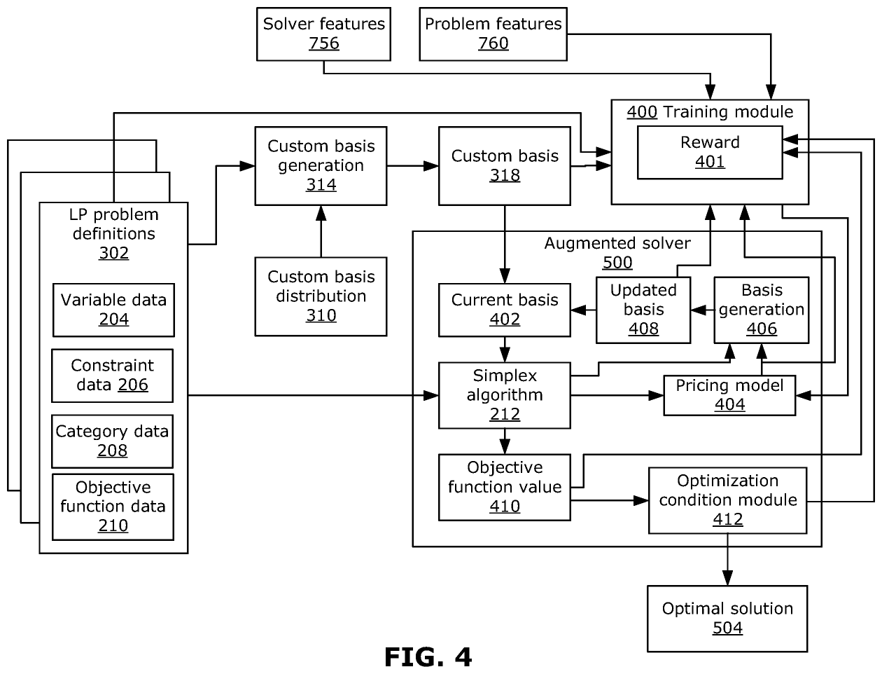

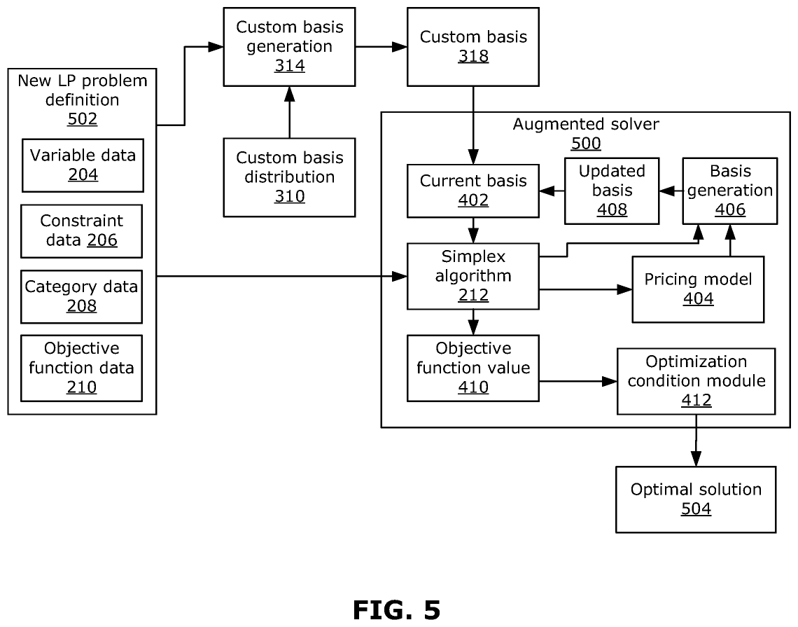

FIG. 4 is a schematic diagram of the operation of an example training module 400 of a LP assistance software system 120. The training module 400 is used to train a pricing model 404 to perform the pricing step of a simplex method performed by an augmented solver 500, which is described in greater detail below with reference to FIG. 5.

In operation, the training module 400 receives a series or set of LP problem definitions 302 defining LP problems of a predetermined type. The series of LP problem definitions 302 is also provided to the custom basis generation module 314, and to the augmented solver 500. For each LP problem defined by the set of LP problem definitions 302, the custom basis generation module 314 applies the custom basis distribution 310 to the LP problem definition 302 to generate a custom basis 318. The custom basis 318 is received by the augmented solver 500, which uses it as the initial basis for solving the LP problem defined by the respective LP problem definition 302.

The augmented solver 500 begins by defining its current basis 402 as the initial basis, i.e. the custom basis 318. A simplex algorithm 212 is applied to perform a first iteration, resulting in an objective function value 410 for the solution of the first iteration. A pricing model 404 is used to perform the pricing step, i.e., to determine the pivot variable(s), based at least in part on the category data 208 of the LP problem definition 302. The simplex algorithm 212 and the pricing model 404 use a basis generation module 406 to generate an updated basis 408, which is used as the current basis 402 for the second iteration. This cycle continues until the LP problem is solved.

An optimization condition module 412 is used to determine when the LP problem has been solved, for example by applying standard simplex techniques to determine that further optimization is possible or that further iterations of the simplex method would result in a less optimal (i.e., lower or higher) objective function value 410. Once the optimization condition module 412 determines that the optimization condition has been satisfied, it outputs the optimal solution 504 of the LP problem. In some embodiments, the augmented solver 500 may also output and/or store other useful information about the solved LP problem, such as the optimal basis 222 and/or the optimal value of the objective function 220 corresponding to the optimal solution 504.

The pricing model 404 is a machine learning model, such as an artificial neural network. The pricing module 404 receives as input from the simplex algorithm 212 various relevant data, such as the current basis 402 (and/or the category distribution of the variables in the current basis 402). On the basis of the category distribution of the current basis 402, the pricing model 404 outputs one or more decisions regarding pricing for the purpose of selecting pivot variable(s) for the updated basis 408. In some embodiments, the pricing model 404 outputs a category for one or more variables to be pivoted out of the basis. In some embodiments, the pricing model 404 outputs a category for one or more variables to be pivoted in to the basis. In some embodiments, the pricing model 404 outputs, for each variable, a price score based at least in part on the category of the variable. The basis generation module 406 uses the output of the pricing model 404 to generate the updated basis 408 by pivoting in and/or pivoting out one or more variables based on the price score or the category or categories identified by the pricing model 404. In some embodiments, the basis generation module 406 applies rules or heuristics provided by the simplex algorithm 212 to select the variables to pivot in and/or out, constrained by the output of the pricing model 404.

Thus, embodiments of the pricing model 404 in which a category is output for the pivot variable(s) make the pivot decision on a per-category basis, whereas embodiments of the pricing model 404 in which a price score is generated for each variable make the pivot decision on a per-variable basis. Examples using a per-variable basis may provide more data inputs to the pricing model than simply the category distribution of the current basis 402: for example, the pricing model may also process inputs such as the constraint data 206, the current objective function value 410, various data generated by the simplex algorithm 212, and so on.

In some embodiments, only a category for the pivot variable (i.e., the incoming variable for primal simplex, the leaving variable for dual simplex) is selected by the pricing model 404, or the price score is only used to select the pivot variable. However, the selection heuristics for selecting a replacement for a pivot variable (i.e., the leaving variable for primal simplex, the incoming variable for dual simplex), while more robust than the heuristics used to select the pivot variable itself, can still make incorrect decision by choosing a variable that was already correctly assigned as basic or non-basic. Thus, some embodiments may also use the pricing model 404 (e.g., using a second sub-model as described below with reference to FIG. 7B) to also assist with the selection of the replacement for the pivot variable (e.g., by selecting the category for the replacement for the pivot variable, or using the price score to select the replacement for the pivot variable).

In some embodiments, the pricing model 404 generates a price score for each variable, allowing selection of pivot variables by the basis generation module 406 on a per-variable basis, instead of on a per-category basis. Embodiments using a price score may provide more input features to the training module 400 than embodiments using the pricing model 404 to simply select the category of the pivot variables. By using additional inputs in training, the pricing model 404 can be trained to make decisions at a per-variable level instead of at a per-category level, since all variables of a category become more distinct from each other due to the additional data. Additional features considered by the training module 400 in embodiments using a price score may include problem-level features 760 that are constant per problem, like the number of non-zero entries per constraint, or the similarity of each constraint compared to the objective solution. The additional features considered may also include solver-level features 756, like the value of a variable, or its reduced cost.

During training, while the augmented solver 500 is solving the series of LP problems, the training module 400 adjusts the learnable parameters of the pricing model 404 using reinforcement learning. Alternative approaches to training the pricing model 404 are also possible—an example using supervised learning is described below with reference to FIG. 7.

In reinforcement learning, a reward 401 is generated by the training module 400 based on the state of the system being monitored. The reward 401 is intended to adjust the behavior of the model being trained, to reinforce behavior that tends to result in desirable behavior, such as increased progress toward a goal. The training module may monitor various data pertaining to the state of the system, such as the current LP problem definition 302, the corresponding custom basis 318, the updated basis 408 for each iteration, and the output of the pricing model 404. In some embodiments, the training module 400 may generate the reward 401 based at least in part on the number of iterations of the simplex algorithm 212 required to satisfy the optimization condition: for example, reducing the reward at each iteration, or applying a negative modifier to the reward at the end of the solving process based on the number of iterations performed, as monitored by, e.g., the optimization condition module 412. In some embodiments, the training module 400 may generate the reward 401 based at least in part on the objective function value 410: for example, applying a modifier to the reward 401 after each iteration proportional to the positive or negative change in the objective value function 410 effected by that iteration. The reward 401 is used by the training module 400 as the basis for adjusting the values of the learnable parameters of the pricing model, for example after each iteration of the simplex algorithm 212.

Example Augmented Solver

FIG. 5 is a schematic diagram of the operation of an example augmented solver 500 of a LP assistance software system 120. After the pricing model 404 has been trained, either using reinforcement learning (as in FIG. 4 above), supervised learning (as in FIGS. 7A-7B), or another machine learning algorithm, the augmented solver 500 can be deployed to solve any new LP problem (defined by new LP problem definition 502) of the predetermined type for which the pricing model 404 has been trained, and on which the custom basis module 300 has based its custom basis distribution 310. For example, the augmented solver 500 can be deployed with the trained pricing model 404 to solve recurrent LP problems in real time (e.g., once a minute, once an hour, or once a day) as they arise.

The augmented solver 500 operates as described above with reference to FIG. 4. Once the pricing model 404 is fully trained, it is capable of generating output to direct the basis generation module 406 to generate the updated basis 408 in such a way that the number of iterations required to solve the LP problem is reduced.

Example Method for AI-Assisted LP Solving

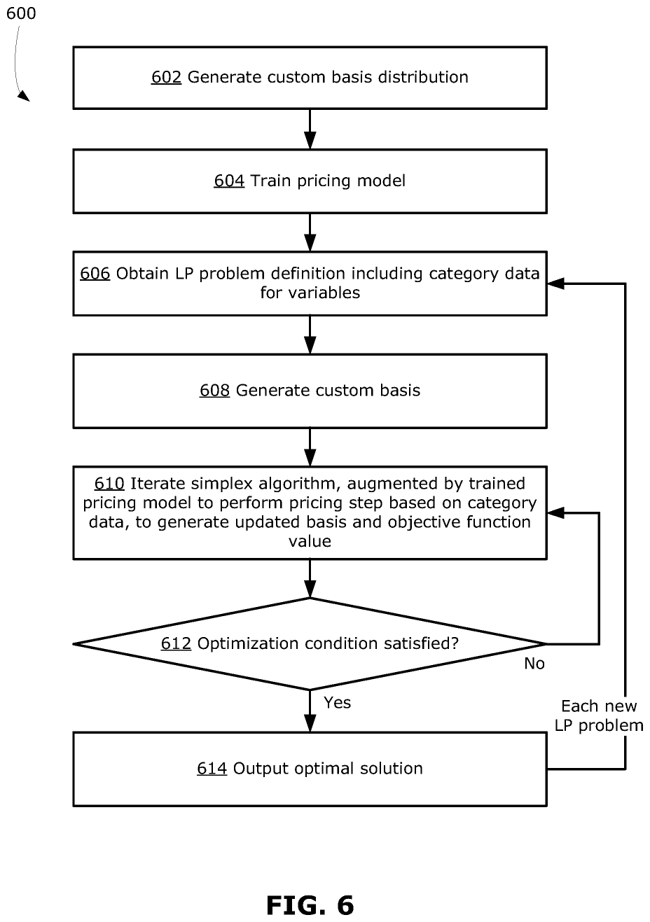

FIG. 6 is a flowchart showing operations of a method 600 for using artificial intelligence to assist a LP solver. The method 600 will be described with reference to the example LP assistance software system 120 described above with reference to FIGS. 3-5; however, it will be appreciated that other examples of the techniques described herein could be used to perform one or more of the steps of method 600, such as the alternative embodiments described below with reference to FIGS. 7A-7B and/or or FIG. 8.

At 602, the custom basis distribution 310 is generated by the custom basis module, as described above with reference to FIG. 3. As described above, some embodiments may perform step 602 only once, whereas other embodiments may update the custom basis distribution 310 on an ongoing basis as new LP problems of the series are obtained and solved.

At 604, the pricing model 404 is trained, as described above with reference to FIG. 4. In some examples, other training techniques, such as those described below with reference to FIGS. 7A-7B, may be used instead. The pricing model is trained to perform the pricing step of the simplex algorithm 212 based at least in part on the category data 208 of the LP problem definitions 302 used in training.

At 606, the LP assistance software system 120 is ready to be deployed to assist in solving new LP problems of the type for which it has been trained and configured. A new LP problem definition 302 is obtained, including category data 208 for its variables.

At 608, the custom basis generation module 314 generates the custom basis 318 for the new LP problem definition 302 based on the custom basis distribution 310 and the category data 208 and variable data 204 of the new LP problem definition 302.

At 610, the simplex algorithm 212 is iterated, augmented by the pricing model 404 to perform the pricing step, based at least in part on the category data 208, as described above with reference to FIGS. 4-5. The pricing model 404 generates output (e.g., categories for incoming and/or outgoing variables, price scores for variables) used by the basis generation module 406 to generate the updated basis 408. The updated basis 408 replaces the current basis 402.

At 612, the optimization condition module 412 determines whether the optimization condition has been satisfied, as described above. If the optimization condition has been satisfied, the method 600 proceeds to 614, otherwise it returns to 610 to perform another iteration of the simplex algorithm 212 using the current basis 402.

At 614, the problem has been solved, and the optimal solution 504 is output by the augmented solver 500. If additional LP problems arise or remain to be solved, the method 600 can return to step 606 to begin solving the next LP problem.

Alternative Training Module Using Supervised Learning

FIG. 7A is a schematic diagram of the operation of an example pricing supervised learning module 700 of a LP assistance software system 120 in an alternative embodiment. In this embodiment, the training module 400 is replaced by a pricing supervised learning module 700 configured to train the pricing model 404 using supervised learning. In supervised learning, a ground truth semantic label on training data are compared to the output of the model after processing a training data sample, and a loss is generated based on the comparison using a loss function 701. In this embodiment, the training data samples are the states of the LP problem being solved (e.g., provided by the simplex algorithm 212), and the labels are a set of corresponding estimated optimal variables 704. Thus, the pricing model 404 is trained directly to select the best pivot variables available. The reward 401 is replaced by labels obtained from the optimal bases 306 and solver-level values, and only the category distribution of the current basis 402 is used as an input to the pricing supervised learning module 700 in supervised learning. In some examples, the estimated optimal variables 704 may be generated using the opinion of a human expert as to the optimal variables to select as pivot variables for a given problem state. In some examples, the estimated optimal variables 704 may be generated as the most desirable variables using standard heuristics (e.g., simplex pivot heuristics), but constrained to those variables that are also optimal basic (i.e., are part of the optimal basis for the LP problem). Because the optimal bases 306 are already known for the LP problems being solved during training, the optimal bases 306 can be used to inform the generation of the training labels. FIG. 7B shows a more detailed diagram for the different data inputs to the pricing supervised learning module 700, in the context of a pricing model 404 configured to select both outgoing and incoming pivot variables.

FIG. 7B is a schematic diagram of the operation of an example pricing supervised learning module 700 of a LP assistance software system 120 in an alternative embodiment using two sub-models 772, 774 for the pricing model 404. A first sub-model 772 selects pivot variables (i.e., the incoming variable for dual simplex, the leaving variable for primal simplex), and a second sub-model 774 selects replacement variables (i.e., the leaving variable for dual simplex, the incoming variable for primal simplex). Each sub-model 772, 774 is trained separately by a respective training sub-module 752, 754 of the pricing supervised learning module 700. The pricing supervised learning module 700 receives inputs including a set of solver features 756 generated by the simplex algorithm 212, a set of problem features 760 based on the LP problem states 758, and a basis distribution 762 indicating the category distribution of the basic variables of the current basis 402. The estimated optimal variables 704, generated based on the optimal bases 306 and guided by the simplex algorithm 212, are used as the training labels.

Optionally, instead of training the pricing model 404 as a LP problem is being solved, randomly generated individual LP problem states 758 can be used to provide a wider variety of states to train the pricing model 404. In that case the simple algorithm 212 is only used to obtain the solver features 756 and estimated optimal variables 704, and no solving iteration is performed.

Alternative Custom Basis Module Trained Using Supervised Learning

FIG. 8 is a schematic diagram of the operation of an example custom basis supervised learning module 800 to train a custom basis generation model 802 of a LP assistance software system 120 in a further alternative embodiment. Whereas the custom basis generation module 314 of FIG. 3 uses a fixed statistical distribution (i.e. custom basis distribution 310) to generate the custom basis for each new LP problem, in this alternative embodiment a machine learning model may be trained, for example using supervised learning, to generate the custom basis based on additional data specific to a given new LP problem. In FIG. 8, the custom basis generation module 314 is replaced by a custom basis generation model 802. The custom basis generation model 802 is trained by a custom basis supervised learning module 800, which generates a loss function 801 based on a comparison between the custom basis 318 generated by the custom basis generation model 802 and training labels in the form of the known optimal bases 306 of the problems being used to train the custom basis generation model 802. Because the optimal bases 306 of the training LP data are already known, they can be used as labels to train the model. The category data 208 and other problem-level features (e.g., variable data 204, constraint data 206, and objective function data 210) are used as inputs to train the custom basis generation model 802 to classify each variable as basic or non-basic for the purpose of generating the custom basis 318.

Once the custom basis generation model 802 has been trained, it is deployed in place of the custom basis generation module 314 to generate the custom basis 318 for each new LP problem solved by the trained augmented solver 500 as shown in FIG. 5. The predictions of the trained custom basis generation model 802, based on the new LP problem definition 502, are used to generate the custom basis 318, which is then used as the current basis 402 for the first iteration performed by the augmented solver 500.

In some examples, the techniques described herein, such as the LP assistance software system 120, could be used as part of existing optimization cloud services. These services could include a recurrent execution mode, wherein the solver would determine that a LP problem is part of the series, then use the solver data to improve its initial basis and decision models for each optimization completed in this series using the techniques described herein.

Examples have been described in which category data 208 is associated with the variables based on user-provided categories (e.g., variable sources) or prefixes in the variable labels. In some examples, category assignment for variables could be performed automatically, by assigning categories based on analyzing the structure of a LP problem (e.g., its constraint data 206). Such categorization may in some examples be less prone to human error, and could potentially identify additional useful categories.

General

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure, are incorporated herein by reference.

1. A method comprising:
obtaining a linear programming (LP) problem definition defining a LP problem of a predetermined type, comprising:
variable data specifying a plurality of variables;
objective function data specifying an objective function of the plurality of variables;
constraint data specifying a plurality of constraints, each constraint constraining a value of at least one of the plurality of variables; and
category data specifying, for each variable of the plurality of variables, a respective category;
obtaining a pricing model trained, using machine learning, to perform a pricing step of a simplex algorithm with respect to LP problems of the predetermined type; and
solving the LP problem by:
generating an initial basis comprising a subset of the plurality of variables, the initial basis being designated as a current basis; and
performing one or more iterations of the simplex algorithm on the current basis, each iteration comprising:
applying the simplex algorithm to the current basis to generate a set of values for the plurality of variables;
generating a value of the objective function based on the set of values for the plurality of variables; and
performing the pricing step of the simplex algorithm by processing the category data, using the pricing model, to generate an updated basis comprising a subset of the plurality of variables, the updated basis being designated as the current basis.

2. The method of claim 1, wherein processing the category data, using the pricing model, to generate the updated basis comprises:
selecting one or more variables to be removed from the current basis to generate the updated basis.

3. The method of claim 2, wherein selecting the one or more variables to be removed from the current basis comprises:
using the pricing model to identify a category to pivot out; and
selecting the one or more variables from the identified category.

4. The method of claim 2, wherein selecting the one or more variables to be removed from the current basis comprises:
using the pricing model to generate, for each variable of the current basis, a price score based at least in part on the category of the variable; and
processing the price scores to select the one or more variables.

5. The method of claim 1, wherein processing the category data, using the pricing model, to generate the updated basis comprises:
processing the category data, using the pricing model, to:
select one or more variables of the plurality of variables for removal from the current basis; and
select one or more variables of the plurality of variables for addition to the current basis.

6. The method of claim 5, wherein selecting the one or more variables for removal from the current basis and selecting the one or more variables for addition to the current basis comprises:
using the pricing model to generate, for each variable of the current basis, a price score based at least in part on the category of the variable; and
processing the price scores to select the one or more variables for removal from the current basis and select the one or more variables for addition to the current basis.

7. The method of claim 1, wherein generating the initial basis comprises:
generating the initial basis as a custom basis based on a plurality of known optimal bases of LP problems of the predetermined type.

8. The method of claim 7, wherein generating the custom basis comprises:
selecting the variables of the subset based on a statistical distribution among the plurality of categories of variables of the plurality of known optimal bases.

9. The method of claim 1, wherein generating the initial basis comprises:
generating the initial basis as a custom basis by:
obtaining a custom basis generation model, trained using machine learning to generate a custom basis for a LP problem of the predetermined type; and
processing the LP problem definition, using the custom basis generation model, to generate the initial basis.

10. The method of claim 9, wherein the custom basis generation model is trained by:
obtaining custom basis training data comprising a plurality of data samples, each data sample comprising:
constraint data for a respective LP problem of the predetermined type; and
an optimal basis for the respective LP problem; and
training the custom basis generation model using supervised learning by, for each data sample:
using the LP problem definition as an input to the custom basis generation model; and
using the optimal basis as a training label.

11. The method of claim 1, wherein the pricing model is trained using reinforcement learning by:
using the pricing model to perform the pricing step of the simplex algorithm in solving a plurality of LP problems of the predetermined type; and
using a reward function based at least in part on a number of iterations of the simplex algorithm required to solve a given LP problem.

12. The method of claim 11, wherein the reward function is also based at least in part on the objective function.

13. The method of claim 1, wherein the pricing model is trained by:
obtaining pricing training data comprising a plurality of data samples, each data sample comprising:
a LP problem definition for a respective LP problem of the predetermined type; and
a current basis of the respective LP problem; and
training the pricing model using supervised learning by, for each data sample:
using the LP problem definition and current basis as inputs to the pricing model; and
using a training label comprising an estimated optimal updated basis.

14. The method of claim 13, wherein the estimated optimal updated basis is based on an expert opinion.

15. The method of claim 13, wherein:
the estimated optimal updated basis is generated using a simplex pricing heuristic constrained by a known optimal basis for the respective LP problem.

16. The method of claim 1, wherein the category of a given variable is based on a respective source of the variable.

17. The method of claim 1, wherein the category of a given variable is based on one or more constraints of the constraint data pertaining to the variable.

18. The method of claim 1, further comprising:
determining that an optimization condition has been satisfied; and
outputting an optimal solution to the LP problem, comprising an optimal set of values for the plurality of variables corresponding to an optimal value of the objective function.

19. The method of claim 2, wherein:
generating the initial basis comprises:
generating the initial basis as a custom basis based on a plurality of known optimal bases of LP problems of the predetermined type; and
the method further comprises:
determining that an optimization condition has been satisfied; and
outputting an optimal solution to the LP problem, comprising an optimal set of values for the plurality of variables corresponding to an optimal value of the objective function.

20. A non-transitory computer-readable medium having instructions tangibly stored thereon that, when executed by a processing system of a computing system, cause the computing system to:
obtain an linear programming (LP) problem definition defining a LP problem of a predetermined type, comprising:
variable data specifying a plurality of variables;
objective function data specifying an objective function of the plurality of variables;
constraint data specifying a plurality of constraints, each constraint constraining a value of at least one of the plurality of variables; and
category data specifying, for each variable of the plurality of variables, a respective category;
obtain a pricing model trained, using machine learning, to perform a pricing step of a simplex algorithm with respect to LP problems of the predetermined type; and
solve the LP problem by:
generating an initial basis comprising a subset of the plurality of variables, the initial basis being designated as a current basis; and
performing one or more iterations of the simplex algorithm on the current basis, each iteration comprising:
applying the simplex algorithm to the current basis to generate a set of values for the plurality of variables;
generating a value of the objective function based on the set of values for the plurality of variables; and
performing the pricing step of the simplex algorithm by processing the category data, using the pricing model, to generate an updated basis comprising a subset of the plurality of variables, the updated basis being designated as the current basis.
